(19) United States
(12) Patent Application Publication
(10) Pub. No.: US 2020/0027224 A1
(43) Pub. Date: Jan. 23, 2020

(54) MEANS FOR PRODUCING AND/OR CHECKING A PART MADE OF COMPOSITE MATERIALS

(71) Applicant: TECHNI-MODUL ENGINEERING, Coudes (FR)

(72) Inventor: Serge LUQUAIN, Saint Germain Lembron (FR)

(73) Assignee: TECHNI-MODUL ENGINEERING, Coudes (FR)

(21) Appl. No.: 16/462,986

(22) PCT Filed: Dec. 14, 2016
(86) PCT No.: PCT/FR2016/053435

§ 371 Date: May 22, 2019

(51) Int. Cl. G06T 7/44; G06T 7/269; G06K 9/62; G06T 5/00; G01N 21/88

(52) U.S. Cl. CPC G06T 7/44; G06T 7/269; G06T 2207/30124; G06T 5/002; G01N 21/8806; G06K 9/6212

(57) ABSTRACT

A method for producing and/or checking a part made of composite materials formed from one fabric having a surface whose texture exhibits a main orientation, including the following steps: obtaining a first image representing the texture of the fabric; determining an estimation relating to the main orientation of the texture, by determining for each pixel of the first image, an orientation of gradients relating to the luminance level of said pixel; determining an estimation of a global distribution of the orientations of gradients of the pixels of the first image; determining the main orientation as a function of the estimation of the global distribution of the orientations of gradients of the pixels of the first image; determining a deviation between the estimation relating to the main orientation and a setpoint value; and producing the part as a function of the deviation and/or emitting a check signal dependent on the deviation.

The present invention relates to the field of production of parts made of composite materials, as well as to quality control processes of said parts. More particularly, the invention relates to the production and/or controls of preforms, adapted to be used to manufacture parts made of composite materials.

The use of parts made of composite materials is steadily increasing, in particular in the field of transportation, in particular due to the potential savings in terms of weight, strength, stiffness or else service life. For example, composite materials are widely used in both the secondary and primary structures of civil and military aircrafts, but also for the making of many elements in motor vehicles or else in railway equipment.

Amongst the known methods for manufacturing parts made of composite materials, the manufacturing method comprising a drape-molding step followed by a baking step in an autoclave, an oven or a press is widely used. Such a process often requires the use of a preform—set of compacted fabrics. To manufacture a preform, it is known to cut, position and form layers of fabric in a manual and non-automated manner. One operator in particular must check on the proper main orientation of the various fabric layers, relative to each other.

Also, such an approach has the drawback of low repeatability when producing a series of complex preforms, each manual intervention being subject to various errors or defects. Furthermore, the productivity of such a method is limited by the necessary controls and by the difficulty of implementing said steps. It is therefore generally desirable to automate the step of producing complex preforms. It is understood that the choice of automation is also conditioned by other criteria in particular by the number of parts to be produced (profitability of the method), by the shape of the part, etc.

Yet, to enable the automation of such a process, for example by deploying robots to manufacture preforms, it is necessary to be able to determine and/or control the main orientation of the used fabric layers, each layer having a directional texture. A texture is described as directional when identifiable elementary structures in said texture are arranged substantially in a main orientation.

Various image analysis methods are known for determining the main orientation of a texture. The document Da-Costa, J. P. «Statistical analysis of directional textures, application to the characterization of composite materials», Thesis of the University of Bordeaux 1, defended on Dec. 21, 2001, describes such a method. However, to determine the main orientation of a texture, the known methods analyze the image of the texture in a dense manner, that is to say by using in an identical manner every pixel or every point of said image. This results in a significant sensitivity to the noise present in the image, which negatively affects the reliability and accuracy of the determination of the main orientation.

There is therefore still a need for means adapted to enable the automated production of parts made of composite materials, in particular preforms, which is economically efficient and which guarantees improved quality, repeatability and accuracy compared to manual methods.

One of the objects of the invention is to provide means adapted to enable the automated production of parts made of composite materials. Another object of the invention is to provide means adapted to enable the determination of the main orientation of a texture, which are not very sensitive to the noise present in the image representing the texture. Another object of the invention is to provide a method for determining an estimate of the main orientation of a particularly robust texture, of very good quality even in the presence of a significant noise in the image representing the texture. Another object of the invention is to propose a method for determining a main orientation error of a texture relative to a reference main orientation, which is particularly robust, of very good quality even in the presence of a large noise in the image representing the texture.

One or more of these objects are met by the method for determining an estimate relating to a main orientation of a texture. The dependent claims further provide solutions to these objects and/or other advantages.

More particularly, according to a first aspect, the invention relates to a method for producing and/or controlling a part made of composite materials formed from at least one fabric having a surface whose texture has a main orientation. The method includes the following steps of:
obtaining a first image formed by a plurality of pixels and in which a luminance level can be determined for each pixel, representing the texture of the fabric;
determining an estimate relating to the main orientation of the texture:

during a first step, by determining, for each pixel of the first image, an orientation of gradients relating to the luminance level of said pixel;

during a second step, by determining an estimate of an overall distribution of the gradient orientations of the pixels of the first image;

during a third step, by determining the main orientation according to the estimate of the overall distribution of the gradient orientations of the pixels of the first image;
determining a deviation between the estimate relating to the main orientation and a setpoint value;
producing the part according to the deviation and/or emitting a control signal depending on the deviation.

Typically, the part made of composite materials is for example composed of a plurality of superimposed fabrics such that the main orientation of each fabric complies with a predetermined sequence. The part may in particular be a preform adapted to be used to manufacture parts made of composite materials, in particular by implementing a process comprising a drape-molding step followed by a baking step in an autoclave, an oven or a press. The method is particularly suited to be implemented by automated devices, such as robots provided with calculation means and an image pick-up device, adapted to dispose the fabrics relative to one another so that the main orientation of each fabric substantially complies with a predetermined sequence.

The setpoint value is for example obtained from a value predefined or calculated, for example, according to the orientation of at least one of the other fabrics forming the part. Alternatively, the setpoint value may be a range of acceptable values.

During the step of producing the part, the position of the fabric can be modified so as to reduce the deviation to a value below a predefined threshold. To this end, the previous steps may be repeated as often as necessary.

During the step of emitting the control signal according to the deviation 40b, the control signal can be generated so as to allow the signaling to a control operator or a quality control device, of a potential fabric orientation defect, when the deviation is greater than a tolerance value greater than a predefined threshold.

During the first step, for each pixel of the first image, the orientation of gradients relating to the luminance level of said pixel can be obtained by:
determining a first response of a first Sobel core-type convolution filter applied to the luminance level according to a first direction;
a second response of a second Sobel core-type convolution filter applied to the luminance level, according to a second direction orthogonal to the first direction;
calculating the argument of a vector whose horizontal component corresponds to the first response and the vertical component corresponds to the second response.

During the second step, the estimate of the overall distribution of the gradient orientations of the pixels of the first image can be determined by constructing a discrete histogram, including a plurality of classes relating to different ranges of possible values for the gradient orientations of the pixels of the first image. The histogram is for example constructed by determining:
for each pixel of the first image, a contribution; and,
for each class, a height equal to the sum of the contributions of all the pixels of the first image whose orientation is comprised in said class.

During the third step, the main orientation can be determined by identifying, in the histogram, the class whose height is maximum. Prior to the first step, the method may include:
a step, during which, for each pixel of the first image, a score relating to the belonging of said pixel to a luminance contour is determined;
a step, during which, for each pixel of the first image, a probability of importance is determined, using the score of said pixel;

and in which, during the second step, the contribution of each pixel is determined according to the probability of importance associated with said pixel. For each pixel of the first image, the score is for example a Harris score, calculated based on the luminance levels of the pixels of the first image. Thus, the presence of noise—for example «salt-and-pepper»—is filtered by the use of the Harris score and the probability of importance. Advantageously, the corners of the first image used to calculate the score of each pixel of the first image may correspond to a break between luminance levels of the first image in one single direction. For each pixel of the first image, the score is for example an estimate of the magnitude of the luminance gradient, based on the luminance levels of the pixels of the first image. For each pixel of the first image, the probability of importance can be determined using a sigmoid function and the score of said pixel.

Prior to the third step, the method may include a step in which the luminance level of each pixel of the first image is filtered so as to reduce the noise present in the luminance information of the first image.

In one embodiment,
during the first step, for each pixel of a reference image of a textured surface, said reference image being formed by a plurality of pixels and in which a luminance level can be determined for each pixel, an orientation of gradients relating to the luminance level of said pixel is determined;
during the second step, a reference estimate of an overall distribution of the gradient orientations of the pixels of the reference image is determined;
during the third step, an error of the main orientation is determined according to the estimate of the overall distribution of the gradient orientations of the pixels of the first image and according to the reference estimate of the overall distribution of the gradient orientations of the pixels of the first image. The deviation between the estimate relating to the main orientation and the setpoint value is determined according to the error of the main orientation. In particular, the setpoint value can be selected according to the reference estimate of the overall distribution of the gradient orientations of the pixels of the reference image.

During the second step, the reference estimate of the overall distribution of the gradient orientations of the pixels of the reference image can be determined by constructing a discrete reference histogram, including a plurality of classes relating to different ranges of possible values for the gradient orientations of the pixels of the reference image, and in which during the third step, the error of the main orientation is determined according to a maximum correlation between the histogram and the reference histogram. During the third step, the maximum correlation between the histogram and the reference histogram can be determined by calculating a measurement of the correlation between the histogram and the reference histogram for a plurality of shifts of the histogram relative to the reference histogram according to a shift angle comprised within a determined interval. During the third step, the measurement of the correlation between the histogram and the reference histogram can be determined according to a Bhattacharyya probabilistic distance, a quality index being determined according to the value of the Bhattacharyya probabilistic distance and the error, and/or an estimate of conformity according to the Bhattacharyya probabilistic distance, during a fourth step.

Other particularities and advantages of the present invention will become apparent from the following description of embodiments with reference to the appended drawings, in which:

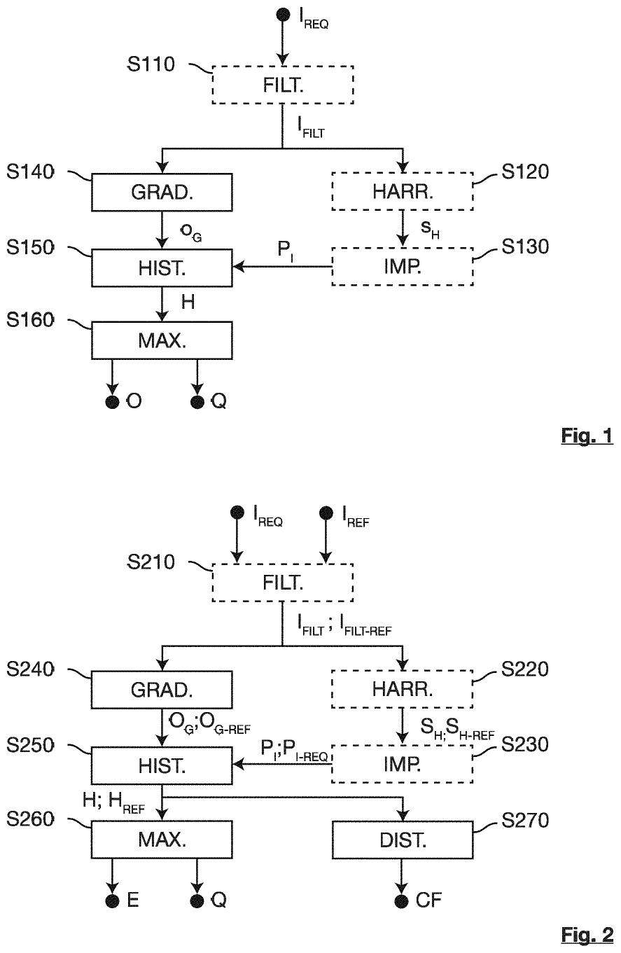

FIG. 1 is a flowchart of the steps of a method for determining an estimate of the main orientation of a texture according to an embodiment of the invention;

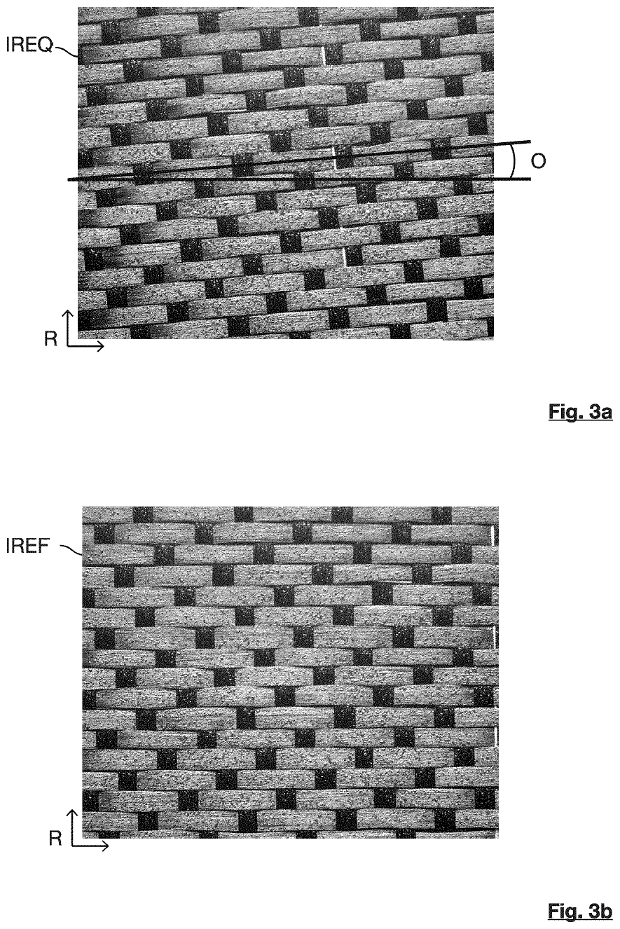

FIG. 2 is a flowchart of the steps of a method for determining a main orientation error of a texture relative to a reference main orientation, according to an embodiment of the invention;

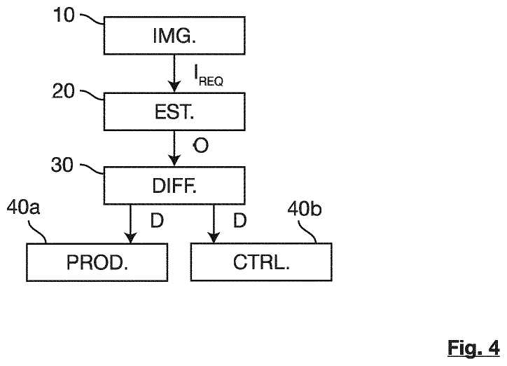

FIG. 3a is a replication of an image of a texture whose main orientation is substantially equal to 5° in the reference frame R;

FIG. 3b is a replication of a reference image of a texture whose main orientation is substantially equal to 0° in the reference frame R;

FIG. 4 is a flowchart of the steps of a method for producing and/or controlling a part made of composite materials, according to an embodiment of the invention.

Referring to FIG. 4, a method for producing and/or controlling a part made of composite materials will now be described. The part made of composite materials is produced from at least one fabric having a surface whose texture has a main orientation O. Typically, the part made of composite materials is composed of a plurality of superimposed fabrics so that the main orientation of each fabric complies with a predetermined sequence. The part may in particular be a preform adapted to be used to manufacture parts made of composite materials, in particular by implementing a process comprising a drape-molding step followed by a baking step in an autoclave, an oven or a press. The method is particularly suited to be implemented by automated devices, such as robots provided with calculation means and an image pick-up device, adapted to dispose the fabrics relative to one another so that the main orientation of each fabric substantially complies with a predetermined sequence.

In the remainder of the description, for illustration purposes, it is considered the case where it is desired to obtain the information on the main orientation of a fabric in a given reference frame so as to control or modify the positioning of said fabric in this reference frame. For example, this situation may be encountered when a robot displaces a fabric from a storage location to an area for manufacturing parts made of composite materials, and that said fabric should be positioned in a particular main orientation. However, during the manufacturing of a part made of composite materials, this operation may be repeated as often as necessary to obtain the final part, typically at least as often as the number of fabrics forming the final part. The orientation of each of the fabrics may be predetermined from a recorded sequence. The orientation of each of the fabrics may also be predetermined from the orientation of at least one of the other fabrics forming the part.

The method includes a step 10 of obtaining a first image I_{REQ} formed by a plurality of pixels and in which a luminance level can be determined for each pixel, representing the texture of the fabric. The image I_{REQ} of the texture includes at least luminance information. Thus, the image I_{REQ} may be a digital image, generally referred to as a luminance image, in which at each pixel x, y is associated at least one value I(x, y) corresponding to a luminance level. The image I_{REQ} can thus be an image called gray level image, each gray value corresponding to a luminance level.

The method includes a step 20 of determining an estimate relating to the main orientation O of the texture, according to the luminance information comprised in an image of said texture.

The method includes a step 30 of determining a deviation D between the main orientation O and a setpoint value. The setpoint value is for example obtained from a value predefined or calculated, for example, according to the orientation of at least one of the other fabrics forming the part. Alternatively, the setpoint value may be a range of acceptable values.

The method includes a step 40a of producing the part according to the deviation D and/or a step 40b of emitting a control signal according to the deviation.

During step 40a, the position of the fabric can be modified so as to reduce the deviation D to a value lower than a predefined threshold. To this end, steps 10 to 40 may be repeated as often as necessary.

During step 40b, the control signal can be generated so as to allow the signaling, to a control operator or a quality control device, of a potential defect of orientation of the fabric, when the deviation E is greater than a tolerance value greater than a predefined threshold.

Referring to FIG. 1 and to FIG. 3a, a first method for determining an estimate of the main orientation of a texture according to an embodiment of the invention will now be described. The first method is particularly adapted to allow the determination 20 of an estimate relating to the main orientation O of the texture, according to the luminance information comprised in an image of said texture, in the method for producing and/or controlling a part made of composite materials.

The first method aims at determining a main orientation in a texture based on the luminance information comprised in an image of said texture. More particularly, the first method aims at determining a main orientation in the texture according to a spatial derivative of the luminance information comprised in the image of said texture. In the remainder of the description, the term «gradient» refers to the spatial derivative of the luminance information comprised in the image of said texture.

The first method is adapted in particular to estimate, in real-time, the main orientation O of a texture, from an image IREQ of said texture, the main orientation O being determined, for a measurements interval M relative to a reference frame R of the image IREQ. Typically, the measurements interval M is [−5° . . . 5° ]. The first method also allows calculating a quality index Q of the estimate of the main orientation O, relating to a degree of confidence or reliability of the estimate of the main orientation O.

The image IREQ of the texture includes at least luminance information. Thus, the image IREQ may be a digital image, generally referred to as a luminance image, in which to each pixel x, y is associated at least one value I(x, y) corresponding to a luminance level. The image IREQ can thus be an image called gray level image, each gray value corresponding to a luminance level.

At a first optional step S110, a filtered image IFILT is determined from the luminance information I(x, y) of the image IREQ, by implementing a method for reducing the noise. The filtered image IFILT can be determined in particular by reducing or suppressing the components relating to the luminance information I(x, y) of the image IREQ whose spatial frequency is higher than a cut-off frequency FC. A spatial convolutional filter whose core is of the Gaussian type can be used to this end. At the end of the first optional step S110, the filtered image IFILT thus obtained includes at least the filtered luminance information IFILT (x, y) of the image IREQ.

Advantageously, the first method includes a second optional step S120 and a third optional step S130.

During the second optional step S120, for each pixel x, y of the filtered image IFILT or of the image IREQ, a score SH relating to the belonging of said pixel to a luminance contour is determined. In particular, a Harris score is calculated from luminance information I(x, y) or filtered luminance information IFILT(x, y). The algorithm called «Harris and Stephen» algorithm allowing calculating SH(x, y) is in particular described in detail in the document Harris, C. & Stephens, M. (1988), «A Combined Corner and Edge Detector», in ‘Proceedings of the 4th Alvey Vision Conference’, pp. 147-151. At the end of the second optional step S120, a first pseudo-image SH is obtained, in which the value of each pixel corresponds to the Harris score associated with the pixel whose coordinates correspond in the filtered image IFILT or in the image IREQ. The Harris score SH(x, y) of a pixel x, y of the filtered image IFILT or of the image IREQ is all the more high as the proximity of said pixel x, y is large in terms of luminance with a corner of the filtered image IFILT or of the image IREQ. The term “corner”, refers to an area of an image where a discontinuity in the luminance information is present, typically when a sudden change in the luminance level is observed between adjacent pixels.

Advantageously, in the filtered image IFILT or in the image IREQ, where each gray value corresponds to a luminance level, the corners taken into account to determine the Harris score SH(x, y) of the pixel x, y, may be the corners corresponding to a break between gray levels in one single direction, the Harris score SH(x, y) of the pixel x, y, then being less than zero. Thus, abrupt breaks in one single direction can be favored.

Alternatively to the calculations of a Harris score, during the second optional step S120, for each pixel x, y of the filtered image IFILT or of the image IREQ, an estimate EGRAD(x, y) of the magnitude of the luminance gradient can be determined from the luminance information I(x, y) or the filtered luminance information IFILT(x, y). A description of a method for determining the estimate EGRAD(x, y) is in particular detailed in the document I. Sobel and G. Feldman, entitled «A 3×3 isotropic gradient operator for image processing», presented at the «Stanford Artificial Project» 1968, conference.

At the third optional step S130, for each pixel x, y of the filtered image IFILT or of the image IREQ, a probability of importance p(x, y) is determined, using the Harris score SH(x, y) of said pixel x, y or the estimate EGRAD(x, y) of the magnitude of the gradient of said pixel x, y. For this purpose, a calibration method can be implemented to obtain the probability of importance p(x, y), for each pixel x, y of the filtered image IFILT or of the image IREQ, from the Harris score SH(x, y) of said pixel or the estimate EGRAD (x, y) of the magnitude of the gradient of said pixel x, y.

The calibration method may for example include a step in which a sigmoid function, whose parameters have been determined empirically, is applied to the first pseudo-image SH, as described for example in the document «Platt, J. (1999). Probabilistic outputs for support vector machines and comparisons to regularized likelihood methods. Advances in large margin classifiers», 10(3), pages 61-74. At the output of the calibration method, a second pseudo-image PI is obtained, in which the value of each pixel corresponds to the probability of importance p(x, y) associated with the pixel whose coordinates correspond in the filtered image IFILT or in the image IREQ.

At a fourth step S140, for each pixel x, y of the filtered image IFILT or of the image IREQ, an orientation OG(x, y) of gradients relating to the luminance level is determined. The orientation OG(x, y) of gradients is densely determined, that is to say using the information of all pixels x, y of said image. For example, to determine the orientation OG(x, y) of the pixel x, y, we calculate:
a first response of a first Sobel core-type convolution filter applied to the luminance level according to a first direction;
a second response of a second Sobel core-type convolution filter applied to the luminance level, according to a second direction orthogonal to the first direction.

The orientation OG(x, y) of the pixel x, y is then obtained by forming a vector whose horizontal component corresponds to the first response and the vertical component corresponds to the second response. The argument of the vector thus formed is thus estimated for an interval [0; 2π], At the end of the fourth step S140, a third pseudo-image OG is obtained, in which the value of each pixel corresponds to the orientation OG(x, y) of gradients associated with the pixel whose coordinates correspond in the filtered image IFILT or in the image IREQ.

At a fifth step S150, an estimate of the overall distribution of the gradient orientations OG(x, y) of the pixels x, y of the filtered image IFILT or of the image IREQ, is determined. The estimate of the overall distribution of the gradient orientations OG(x, y) is, for example, a discrete histogram H, including a plurality of classes relating to different ranges of possible values for the gradient orientations OG(x, y). The histogram H is constructed by determining:
for each pixel x, y a contribution C(x, y); and,
for each class, a height equal to the sum of the contributions C(x, y) of all the pixels whose orientation OG(x, y) is comprised in said class.

The contribution C(x, y) of each pixel x, y can be selected constant, for example equal to 1.

Advantageously, in the case where the second pseudo-image PI is available, the contribution C(x, y) of each pixel x, y may be a function of the probability of importance p(x, y) associated with said pixel.

At a sixth step S160, the main orientation O is determined according to the estimate of the overall distribution of the gradient orientations, the pixels x, y of the filtered image IFILT or of the image IREQ. In particular, the main orientation O can be determined by identifying, in the histogram H, the class whose height is maximum.

Referring to FIGS. 2, 3a and 3b, a second method for determining a main orientation error E of a texture relative to a reference main orientation, according to an embodiment of the invention, will now be described. The second method is in particular adapted to allow the determination 20 of an estimate relating to the main orientation O of the texture, according to the luminance information comprised in an image of said texture, in the method for producing and/or controlling a part made of composite materials. The second method is adapted to determine the main orientation error E in the texture according to the luminance information comprised in an image IREQ of said texture, and according to the luminance information comprised in a reference image IREF. The second method also allows determining a quality index Q of the estimate of the error E, relating to a degree of confidence or reliability of the estimate of the error E, as well as a conformity estimate CF. In the remainder of the description, the term «gradient» refers to the spatial derivative of the luminance information comprised in the image of said texture. From an image of the textured surface of said part, and an image of a textured surface considered as a reference to be reached in terms of main orientation of the fibers of the part to be manufactured, it is then possible to determine an estimate of the error E and undertake the corrective steps that may then be necessary during step 40a.

The image IREQ of the texture includes at least luminance information. Thus, the image IREQ may be a digital image, generally referred to as a luminance image, in which to each pixel x, y is associated at least one value I(x, y) corresponding to a luminance level. The image IREQ can thus be an image called a gray level image, each gray value corresponding to a luminance level.

The reference image IREF is an image with a textured surface considered as a reference to which the image IREQ should be compared in terms of main orientation of the fibers. The reference image IREF includes at least luminance information. Thus, the reference image IREF may be a digital image, generally referred to as a luminance image, in which to each pixel x, y is associated at least one value I(x, y) corresponding to a luminance level. The reference image IREF can thus be an image called a gray level image, each gray value corresponding to a luminance level.

At a first optional step S210, a filtered image IFILT is determined from the luminance information I(x, y) of the image IREQ, by implementing a method for reducing the noise. The filtered image IFILT can be determined in particular by reducing or suppressing the components relating to the luminance information I(x, y) of the image IREQ whose spatial frequency is higher than a cut-off frequency FC. A spatial convolutional filter whose core is of the Gaussian type can be used to this end. At the end of the first optional step S210, the filtered image IFILT thus obtained includes at least the filtered luminance information IFILT(x, y) of the image IREQ. During the first optional step S210, a reference filtered image IFILT-REQ is determined, based on the luminance information I(x, y) of the reference image IREF, by implementing a method for reducing the noise. The reference filtered image IREF can be determined in particular by reducing or suppressing the components relating to the luminance information I(x, y) of the reference image IREF whose spatial frequency is higher than a cut-off frequency FC. A spatial convolutional filter whose core is of the Gaussian type can be used to this end. At the end of the first optional step S210, the reference filtered image IFILT-REF thus obtained includes at least the filtered luminance information IFILT-REF(x, y) of the reference image IREF.

Advantageously, the second method includes a second optional step S220 and a third optional step S230.

During the second optional step S220, for each pixel x, y of the filtered image IFILT or of the image IREQ, a Harris score is calculated, based on the luminance information I(x, y) or the filtered luminance information IFILT(x, y). The algorithm called «Harris and Stephen» algorithm allowing calculating SH(x, y) is in particular described in detail in the document Harris, C. & Stephens, M. (1988), «A Combined Corner and Edge Detector», in ‘Proceedings of the 4th Alvey Vision Conference’, pp. 147-151. At the end of the second optional step S220, a first pseudo-image SH is obtained, in which the value of each pixel corresponds to the Harris score associated with the pixel whose coordinates correspond in the filtered image IFILT or in the image IREQ. The Harris score SH(x, y) of a pixel x, y of the filtered image IFILT or of the image IREQ is all the more high as the proximity of said pixel x, y is large in terms of luminance with a corner of the filtered image IFILT or of the image IREQ. The term “corner” refers to an area of an image where a discontinuity in the luminance information is present, typically when a sudden change in the luminance level is observed between adjacent pixels.

Advantageously, in the filtered image IFILT or in the image IREQ, where each gray value corresponds to a luminance level, the corners taken into account to determine the Harris score SH(x, y) of the pixel x, y, may be the corners corresponding to a break between gray levels in one single direction, the Harris score SH(x, y) of the pixel x, y, then being less than zero. Thus, abrupt breaks in one single direction can be favored.

Alternatively to the calculations of a Harris score, during the second optional step S220, for each pixel x, y of the filtered image IFILT or of the image IREQ, an estimate EGRAD(x, y) of the magnitude of the luminance gradient can be determined from the luminance information I(x, y) or the filtered luminance information IFILT(x, y).

During the second optional step S220, for each pixel x, y of the reference filtered image IFILT-REF or of the reference image IREF, a Harris score SH-REF(x, y) is calculated based on luminance information IREF(x, y) or filtered luminance information IFILT-REF(x, y). At the end of the second optional step S220, a first reference pseudo-image SH-REF is obtained, in which the value of each pixel corresponds to the Harris score associated with the pixel whose coordinates correspond in the reference filtered image IFILT-REF or in the reference image IREF. The Harris score SH-REF(x, y) of a pixel x, y of the reference filtered image IFILT-REF or of the reference image IREF is all the more high as the proximity of said pixel x, y is large in terms of luminance with a corner of the reference filtered image IFILT-REF or of the reference image IREF.

Advantageously, in the reference filtered image IFILT-REF or the reference image IREF, where each gray value corresponds to a luminance level, the corners taken into account to determine the Harris score SH-REF(x, y) of the pixel x, y, may be the corners corresponding to a break between gray levels in a single direction, the Harris score SH(x, y) of the pixel x, y, then being less than zero. Thus, abrupt breaks in one single direction can be favored.

Alternatively to the calculations of a Harris score, during the second optional step S220, for each pixel x, y of the reference filtered image IFILT-REF or of the reference image IREF, an estimate EGRAD-REF(x, y) of the magnitude of the luminance gradient can be determined based on the luminance information IREF(x, y) or the filtered luminance information IFILT-REF(x, y).

At the third optional step S230, for each pixel x, y of the filtered image IFILT or of the image IREQ, a probability of importance p(x, y) is determined, using the Harris score SH(x, y) of said pixel x, y or of the estimate EGRAD(x, y) of the magnitude of the gradient of said pixel x, y. For this purpose, a calibration method can be implemented to obtain the probability of importance p(x, y), for each pixel x, y of the filtered image IFILT or of the image IREQ, from the Harris score SH(x, y) of said pixel or the estimate EGRAD(x, y) of the magnitude of the gradient of said pixel x, y.

The calibration method may for example include a step in which a sigmoid function, whose parameters have been empirically determined, is applied to the first pseudo-image SH. At the output of the calibration method, a second pseudo-image PI is obtained, in which the value of each pixel corresponds to the probability of importance p(x, y) associated with the pixel whose coordinates correspond in the filtered image IFILT or in the image IREQ.

At the third optional step S230, for each pixel x, y of the reference filtered image IFILT-REF or of the reference image IREF, a probability of importance pREF(x, y) is determined, using the Harris score SH-REF(x, y) of said pixel x, y or the estimate EGRAD-REF(x, y) of the magnitude of the gradient of said pixel x, y. For this purpose, a calibration method can be implemented to obtain the probability of importance pREF(x, y), for each pixel x, y of the reference filtered image IFILT-REF or of the reference image IREF, from the Harris score SH-REF(x, y) of said pixel or from the estimate EGRAD-REF(x, y) of the magnitude of the gradient of said pixel x, y.

The calibration method may for example include a step in which a sigmoid function, whose parameters have been empirically determined, is applied to the first pseudo-image SH-REF. At the output of the calibration method, a second pseudo-image PI-REF is obtained, in which the value of each pixel corresponds to the probability of importance pREF(x, y) associated with the pixel whose coordinates correspond in the reference filtered image IFILT-REF or in the reference image IREF.

At a fourth step S240, for each pixel x, y of the filtered image IFILT or of the image IREQ, an orientation OG(x, y) of gradients relating to the luminance level is determined. The orientation OG(x, y) of gradients is densely determined, that is to say by using the information of all the pixels x, y of said image. For example, to determine the orientation OG(x, y) of the pixel x, y, we calculate:
a first response of a first Sobel core-type convolution filter applied to the luminance level according to a first direction;
a second response of a second Sobel core-type convolution filter applied to the luminance level, according to a second direction orthogonal to the first direction.

The orientation OG(x, y) of the pixel x, y is then obtained by forming a vector whose horizontal component corresponds to the first response and the vertical component corresponds to the second response. The argument of the vector thus formed is thus estimated for an interval [0; 2π]. At the end of the fourth step S240, a third pseudo-image OG is obtained, in which the value of each pixel corresponds to the orientation OG(x, y) of gradients associated with the pixel whose coordinates correspond in the filtered image IFILT or in the image IREQ.

During the fourth step S240, for each pixel x, y of the reference filtered image IFILT-REF or of the reference image IREF, an orientation OG-REF(x, y) of gradients relating to the luminance level is determined. The orientation OG-REF(x, y) of gradients is densely determined, that is to say by using the information of all the pixels x, y of said image. For example, to determine the orientation OG-REF(x, y) of the pixel x, y, we calculate:
a first response of a first Sobel core-type convolution filter applied to the luminance level according to a first direction;
a second response of a second Sobel core-type convolution filter applied to the luminance level, according to a second direction orthogonal to the first direction.

The orientation OG-REF(x, y) of the pixel x, y is then obtained by forming a vector whose horizontal component corresponds to the first response and the vertical component corresponds to the second response. The argument of the vector thus formed is thus estimated for an interval [0; 2π]. At the end of the fourth step S240, a third pseudo-image OG-REF is obtained, in which the value of each pixel corresponds to the orientation OG-REF(x, y) of gradients associated with the pixel whose coordinates correspond in the reference filtered image IFILT-REF or in the reference image IREF.

At a fifth step S250, an estimate of the overall distribution of the gradient orientations OG(x, y) of the pixels x, y of the filtered image IFILT or of the image IREQ, is determined. The estimate of the overall distribution of the gradients OG(x, y) is, for example, a discrete histogram H, including a plurality of classes relating to different ranges of possible values for the gradient orientations OG(x, y). The histogram H is constructed by determining:
for each pixel x, y a contribution C(x, y); and,
for each class, a height equal to the sum of the contributions C(x, y) of all the pixels whose orientation OG(x, y) is comprised in said class.

The contribution C(x, y) of each pixel x, y can be selected constant, for example equal to 1.

Advantageously, in the case where the second pseudo-image PI is available, the contribution C(x, y) of each pixel x, y may be a function of the probability of importance p(x, y) associated with said pixel.

During the fifth step S250, a reference estimate of the overall distribution of the gradient orientations OG-REF(x, y) of the pixels x, y of the reference filtered image IFILT-REQ or of the reference image IREF, is determined. The reference estimate of the overall distribution of the gradients OG-REF(x, y) is, for example, a discrete reference histogram HREF, including a plurality of classes relating to different ranges of possible values for the gradient orientations OG-REF(x, y). The reference histogram HREF is constructed by determining:
for each pixel x, y a contribution CREF(x, y); and,
for each class, a height equal to the sum of the contributions CREF(x, y) of all the pixels whose orientation OG-REF(x, y) is comprised in said class.

The contribution CREF(x, y) of each pixel x, y can be selected constant, for example equal to 1.

Advantageously, in the case where the second pseudo-image PI-REF is available, the contribution CREF(x, y) of each pixel x, y may be a function of the probability of importance pREF(x, y) associated with said pixel.

At a sixth step S260, the main orientation O is determined according to:
the estimate of the overall distribution of the gradient orientations of the pixels x, y of the filtered image IFILT or of the image IREQ; and,
the reference estimate of the overall distribution of the gradient orientations OG-REF(x, y) of the pixels x, y of the reference filtered image IFILT-REF or of the reference image IREF.

In particular, a maximum correlation between the histogram H and the reference histogram HREF can be pursued. Thus, it is possible, for example, to evaluate a measurement of the correlation between the histogram H and the reference histogram HREF, by varying the shift of the histogram H relative to the reference histogram HREF by a shift angle evolving in steps of 0.1° between −10° and 10°. The measurement of the correlation between the histogram H and the reference histogram HREF is, for example, determined as a function of the Bhattacharyya probabilistic distance, described in particular in the document entitled Kailath, T., (1967), «The Divergence and Bhattacharyya Distance Measures in Signal Selection», IEEE Transactions on Communication Technology, vol. 15, No. 1, 1967, p. 52-60. The estimate of the error E is then equal to the shift angle for which a maximum correlation is observed. The quality index Q is then a function of the value of the Bhattacharyya distance associated with the estimate of the error E.

At a seventh step S270, a conformity estimate CF based on a statistical distance between the histogram H and the reference histogram HREF is determined. Thus, it is possible, for example, to determine the Bhattacharyya probabilistic distance between the histogram H and the reference histogram HREF. The conformity estimate CF is then obtained according to the Bhattacharyya probabilistic distance between the histogram H and the reference histogram HREF, typically by subtracting 1 from said Bhattacharyya probabilistic distance.

1. A method for producing and/or controlling a part made of composite materials formed from at least one fabric having a surface whose texture has a main orientation, wherein it includes the following steps of:
obtaining a first image formed by a plurality of pixels and in which a luminance level can be determined for each pixel, representing the texture of the fabric;
determining an estimate relating to the main orientation of the texture:
during a first step, by determining, for each pixel of the first image, an orientation of gradients relating to the luminance level of said pixel;
during a second step, by determining an estimate of an overall distribution of the gradient orientations of the pixels of the first image;
during a third step, by determining the main orientation according to the estimate of the overall distribution of the gradient orientations of the pixels of the first image;
determining a deviation between the estimate relating to the main orientation and a setpoint value;
producing the part according to the deviation and/or emitting a control signal depending on the deviation.

2. The production and/or control method according to claim 1, wherein, during the first step, for each pixel of the first image, the orientation of gradients relating to the luminance level of said pixel is obtained by:
determining a first response of a first Sobel core-type convolution filter applied to the luminance level according to a first direction;
a second response of a second Sobel core-type convolution filter applied to the luminance level, according to a second direction orthogonal to the first direction;
calculating the argument of a vector whose horizontal component corresponds to the first response and the vertical component corresponds to the second response.

3. The production and/or control method according to claim 1, wherein during the second step, the estimate of the overall distribution of the gradient orientations of the pixels of the first image is determined by constructing a discrete histogram, including a plurality of classes relating to different ranges of possible values for the gradient orientations of the pixels of the first image.

4. The production and/or control method according to claim 3, wherein the histogram is constructed by determining:
for each pixel of the first image, a contribution; and,
for each class, a height equal to the sum of the contributions of all the pixels of the first image whose orientation is comprised in said class.

5. The production and/or control method according to claim 4, wherein, during the third step, the main orientation is determined by identifying, in the histogram, the class whose height is maximum.

6. The production and/or control method according to claim 4, further including, prior to the first step:
a step, during which, for each pixel of the first image, a score relating to the belonging of said pixel to a luminance contour is determined;
a step, during which, for each pixel of the first image, a probability of importance is determined, using the score of said pixel;
and wherein, during the second step, the contribution of each pixel is determined according to the probability of importance associated with said pixel.

7. The production and/or control method according to claim 6, wherein, for each pixel of the first image, the score is a Harris score, calculated based on the luminance levels of the pixels of the first image.

8. The production and/or control method according to claim 7, wherein the corners of the first image used to calculate the score of each pixel of the first image correspond to a break between luminance levels of the first image in one single direction.

9. The production and/or control method according to claim 6, wherein, for each pixel of the first image, the score is an estimate of the magnitude of the luminance gradient, based on the luminance levels of the pixels of the first image.

10. The production and/or control method according to claim 6, wherein, for each pixel of the first image, the probability of importance is determined using a sigmoid function and the score of said pixel.

11. The production and/or control method according to claim 1, further including, prior to the third step, a step during which the luminance level of each pixel of the first image is filtered so as to reduce the noise present in the luminance information of the first image.

12. The production and/or control method according to claim 1, wherein:
during the first step, for each pixel of a reference image of a textured surface, said reference image being formed by a plurality of pixels and in which a luminance level can be determined for each pixel, an orientation of gradients relating to the luminance level of said pixel is determined;
during the second step, a reference estimate of an overall distribution of the gradient orientations of the pixels of the reference image is determined;
during the third step, an error of the main orientation is determined according to the estimate of the overall distribution of the gradient orientations of the pixels of the first image and according to the reference estimate of the overall distribution of the gradient orientations of the pixels of the first image;
and wherein the deviation between the estimate relating to the main orientation and the setpoint value is determined according to the error of the main orientation.

13. The production and/or control method according to claim 3, wherein, during the second step, the reference estimate of the overall distribution of the gradient orientations of the pixels of the reference image is determined by constructing a discrete reference histogram, including a plurality of classes relating to different ranges of possible values for the orientations of the gradients of the pixels of the reference image, and wherein during the third step, the error of the main orientation is determined according to a maximum correlation between the histogram and the reference histogram.

14. The production and/or control method according to claim 13, wherein, during the third step, the maximum correlation between the histogram and the reference histogram is determined by calculating a measurement of the correlation between the histogram and the reference histogram for a plurality of shifts of the histogram relative to the reference histogram according to a shift angle comprised within a determined interval.

15. The production and/or control method according to claim 14, wherein, during the third step, the measurement of the correlation between the histogram and the reference histogram is determined according to a Bhattacharyya probabilistic distance, a quality index being determined according to the value of the Bhattacharyya probabilistic distance and the error, and/or an estimate of conformity according to the Bhattacharyya probabilistic distance, during a fourth step.
